(19) United States
(12) Patent Application Publication
(10) Pub. No.: US 2007/0169414 A1
(43) Pub. Date: Jul. 26, 2007

(54) Push-pull chain actuator

(75) Inventor: Jens Joerren Soerensen, Copenhagen (DK)

Correspondence Address: CROCKETT & CROCKETT, 24012 CALLE DE LA PLATA, SUITE 400, LAGUNA HILLS, CA, 92653, US

(73) Assignee: VKR Holding A/S

(21) Appl. No.: 11/656,631

(22) Filed: Jan. 22, 2007

(30) Foreign Application Priority Data
Jan. 25, 2006 (EP) 06001507.0

(51) Int. Cl. E05F 11/00

(52) U.S. Cl. 49/325

(57) ABSTRACT

A push-pull chain type window actuator with an elongated and slim housing. The actuator is slim enough for mounting inside a window frame. The housing includes a chain path in communication with a chain exit. The push pull chain is engaged by a sprocket that is driven via a transmission by two or more electric drive motors in tandem. An auxiliary axial bearing supports the drive shafts of the electric drive motors. The transmission includes a worm gear. In order to extend the life span of the wormwheel the thickness of the teeth of the metal worm is chosen to be significantly less than the thickness of the plastic wormwheel. A resilient stop block dampens the halt of the push-pull chain at the end of the outward stroke.

This application claims priority to European Application 06001507.0, filed Jan. 25, 2006.

### FIELD OF THE INVENTIONS

The present invention relates to push-pull chain type window actuators, in particular to push-pull chains actuators with an elongated and slim housing that have traverse cross-sectional dimensions small enough to mount the actuator inside a window frame. These actuators are used for electric operation of windows and include a sprocket, an elongated and slim actuator housing provided with a chain path in communication with a chain exit opening, a push-pull chain being at least partially received in the chain path and being engaged by the sprocket and an electric drive motor with a drive shaft coupled to the sprocket via a transmission.

### BACKGROUND ART

Push-pull chain type window actuators are widely used for opening and closing windows in automated systems for natural ventilation of buildings. Natural Ventilation regulates the indoor climate of the building by means of a controlled air change through the windows. The natural driving forces are created by temperature differences between indoors and outdoors as well as the wind around the building. The air in the building is kept fresh by ventilation through windows in the facades and the roof. The ventilation is achieved by controlled opening and closing of the windows depending on the outdoor and indoor climate and the need for fresh air. The natural driving forces are free, for which reason Natural Ventilation is very energy-efficient for the benefit of both the environment and the operating economy of buildings. Natural Ventilation allows the design of light, airy and spacious buildings, is economic and provides a good indoor climate. A natural ventilation system comprises sensors, actuators build into window frames and a central computer controlling the opening and closing of the respective windows on the basis of a control program that takes into account the measured parameters and programmed information.

U.S. Pat. No. 6,890,279 discloses a push-pull chain type window actuator a magazine for a push-pull chain, a sprocket, an electric drive motor and a worm gear coupled with the drive shaft of the drive motor. A reduction gear is inserted between the worm gear and the sprocket.

This type of actuators requires a relatively large and powerful electric drive motor to be able to handle the maximum load on the window. This load can be relatively heavy under high winds conditions or when snow has piled upon the window. Increasing drive motor power tends to result in an increase in diameters of the generally cylindrical shaped motors. In this type of in window actuators there us usually ample longitudinal space available, whereas the traverse space available is relatively small. Therefore, the goal is to develop a slim and elongated actuator that can be readily mounted in inside a window frame. An increase in diameter of the electric drive motor will usually result in a corresponding increase in the traverse diameter of the actuator housing since the electric drive motor is one of the determining factors when minimizing the traverse dimensions of the window actuator.

Another determining factor when minimizing the traverse dimensions of the window actuator is the size of the transmission. In order to withstand the load and last the lifespan of the actuator the transmission needs to be rugged whilst also being compact. Also, a relatively high reduction ratio is required to amplify the torque of the drive motor.

Further, it is of advantage if the transmission is self-locking, so that the window can be held in place with a load thereon without the need for a break mechanism. A transmission including a worm gear can fulfill most of these criteria relatively well. A worm gear offers a maximum speed reduction in the smallest package and is self-locking if the lead angle of the worm is less than the friction angle. Known push-pull chain type window actuators typically comprise a worm gear with a metal worm meshing with a plastic wormwheel. This combination of materials offers low friction and reasonable wear resistance.

The worm transmits a substantial axial force to the drive shaft of the electric drive motor on which the worm is mounted. This axial can be handled by the roller bearings of expensive industrial type electric drive motors used in some of the prior art actuators.

### DISCLOSURE OF THE INVENTION

On this background, it is an object of the present invention to provide a push-pull chain actuator of the kind referred to initially, which can be constructed with smaller traverse housing dimensions whilst offering the same performance.

This object is achieved in accordance with claim 1 by providing a push-pull chain type window actuator for mounting inside or on a window frame comprising a sprocket, an elongated and slim actuator housing provided with a chain path in communication with a chain exit opening, a push-pull chain being at least partially received in the chain path and being engaged by the sprocket, an electric drive motor with a drive shaft coupled to the sprocket via a transmission, and at least one further electric drive motor with a drive shaft coupled to rotate in unison with the drive shaft of the electric motor.

Two electric drive motors directly coupled to one another offer a high torque in combination with small traverse dimensions. By arranging the electric drive motors in tandem the length of the actuator increases, but this is not a real tradeoff since there is ample space lengthwise. Unexpectedly, it turned out that two small “off the shelf” electric drive motors cost less than one slim bodied high end electric drive motor.

The axis of the drive shaft of the electric drive motor may be arranged substantially in parallel with the longitudinal axis of the housing. Preferably, the axis of the drive shaft of the electric drive motor and the axis of the drive shaft of the at least one further electric drive motor substantially coincide.

The opposite ends of the drive shaft of the electric drive motor protrude from the opposite sides of the housing of the electric drive motor. Preferably, the drive shaft of the at least one further electric drive motor is coupled to one of the opposite ends whilst the transmission is coupled to the other one of the opposite ends. Thus, the electric drive motors are arranged in tandem and form a slim and powerful drive unit.

The transmission may comprise a worm and a wormwheel, the worm being driven by one of the drive shafts. Thus, a maximum speed reduction is obtained in a small package. The worm may be directly mounted on an end of the drive shaft of the electric drive motor.

The other end of the drive shaft of the electric drive motor may be coupled to the end of the drive shaft of the further electric drive motor by a direct mechanical connection. Thus, a solid and reliable coupling between the eclectic drive motors is established.

Preferably, the electric drive motor and the further electric drive motor have substantially cylindrical housings with equal diameters.

The elongated actuator housing preferably has a substantially cuboid shape, and whereby at least one of the two traverse dimensions of the housing is substantially equal to the diameter of the housing of the electric drive motors.

The actuator may further comprise a supplementary axial bearing supporting one or both of the drive shafts. Thus, the axial load generated by the interaction between the worm and the wormwheel can be withstood without overloading the plastic slide bearings of less expensive electric drive motors

Preferably, the supplementary axial bearing is resiliently suspended from the housing.

The object above can also be achieved in accordance with claim 14 by providing a push-pull chain type window actuator for mounting inside or on a window frame comprising an elongated and slim actuator housing provided with a chain path in communication with a chain exit opening, a push-pull chain being at least partially received in the chain path and operably coupled to a drive mechanism including a worm and wormwheel, an electric drive motor, the wormwheel being mounted on the drive shaft of the electric drive motor, further comprising a supplementary axial bearing supporting the drive shaft.

By providing an axial bearing a relatively small electric drive motor can be used without overloading the simple plastic/resin slide bearings that small “off the shelve” electric motors are provided with.

Preferably, the supplementary axial bearing is at least in an axial direction resiliently suspended from the housing. Thus, vibrations and noise are reduced.

Preferably, the supplementary axial bearing is rigidly connected to a traverse plate member, whereby the plate member is sandwiched between two resilient plate members. Thus a compact and resilient suspension is provided for the axial bearing. Preferably, the plate member and the resilient plate member fit tightly in a recess in the elongate slim housing.

The plate member and the resilient plate members may have a substantially circular contour, thereby reducing the chances of the bearing being incorrectly fitted.

The axial bearing can be a deep groove roller bearing, preferably a single row deep groove ball bearing.

The object above can also be achieved in accordance with claim 22 by providing a push-pull chain type window actuator for mounting inside or on a window frame comprising an elongated and slim actuator housing provided with a chain path in communication with a chain exit opening, a push-pull chain being at least partially received in the chain path and being operably coupled to a drive mechanism including a metal worm meshing with a non-metallic wormwheel, an electric drive motor, the worm being mounted on the drive shaft of the electric drive motor, wherein the tooth thickness of the teeth of the worm is substantially smaller than the tooth thickness of the teeth of the wormwheel.

The inventor has realized that transmission failure is often caused by the teeth of the plastic wormwheel wearing off much faster than the harder teeth of the metal worm. By reducing the tooth thickness of the teeth of the worm and increasing the tooth thickness of the teeth of the wormwheel, the teeth of the latter gearwheel have more material to be worn off. Thus, the point at which the teeth of the wormwheel reach a critical minimum thickness due to wear is significantly delayed without needing to increase the dimensions of the transmission.

Preferably, the profile angle—the angle between a tangent to a tooth profile and the radius from the gear axis to the tangent point—of the worm and the wormwheel is substantially less than 20°, preferably between 8 and 16°. A lower profile angle facilitates the creating of a thread with thin teeth.

The worm can be made of carbon steel and the wormwheel made of a plastic resin, such as nylon, acetal copolymer, polybutylene terephthalate (PBT), linear polyphenylene sulfide (PPS), PTFE-lubricated linear PPS or composites.

Preferably, the tooth thickness of the teeth of the worm is equal to or less than half of the tooth thickness of the wormwheel.

The object above can also be achieved in accordance with claim 27 by providing a push-pull chain type window actuator comprising a sprocket, an elongated and slim actuator housing provided with a chain path in communication with a chain exit opening, a push-pull chain being at least partially received in the chain path and being operably coupled to a drive mechanism including a metal worm meshing with a non-metallic wormwheel, an electric drive motor, the worm being mounted on the drive shaft of the electric drive motor, a spur gear with at least two stages, with a first gear wheel meshing with a second gearwheel to form the first stage and the second gear wheel meshing with a third gearwheel to form the second stage, wherein the second gearwheel has a given width at its meshing edge, the first gearwheel meshes with the second gearwheel in a first contact length that is less than the width of the meshing edge and the first contact length extends along the width starting from a first side of the second gearwheel towards the second opposite side of the second gearwheel, the third gearwheel meshes with the second gearwheel in a second contact length that is less than the width of the meshing edge, and the second contact length extends along the width starting from the second side of the second gearwheel towards the first side of the second gearwheel.

Thus, the third gearwheel can be placed very close to the outer side surface of the housing, thereby creating place for a large, robust and stable chain, whilst the side of the first gearwheel adjacent the housing can be disposed at a somewhat larger distance of the outer side surface of the housing to create space for an at least locally increased wall thickness.

Preferably, the first-, second-, and third gearwheels are each mounted on a shaft with the ends of each of the shafts being received in recesses in oppositely disposed walls of the housing.

The first gearwheel may be a relatively small diameter gearwheel and the second- and third gearwheels may be relatively large diameter gearwheels provided with a countersink in a side of the gearwheel adjacent a housing wall.

It is another object of the invention to provide a more comfortable push-pull chain type window actuator. This object is achieved in accordance with claim 31 by providing a push-pull chain type window actuator comprising a sprocket, an elongated and slim actuator housing provided with a chain path in communication with a chain exit opening, a push-pull chain being at least partially received in the chain path and being engaged by the sprocket, an electric drive motor with a drive shaft coupled to the sprocket via a transmission, and the push pull chain having a distal end of connection to a window sash to be actuated and a proximate end pivotally attached to the actuator housing, the final link at the proximate end of the push pull chain swinging from a first orientation to another orientation during the final part of the outward movement of the push-pull and abuts with a resilient rubber stop block disposed in the actuator housing to thereby dampen the halt of the push pull chain at the end of its outward stroke.

The resilient stop block cause the halt of the chain at the end of the outward stroke to be dampened, which in turn also causes the sash of the window being opened to stop more smoothly. Noise and vibration levels as well as peak mechanical loads on the components of the actuator and the window at the halt of the outward stroke are thus reduced.

Preferably, the actuator housing includes a chain attachment block provided with a bore for receiving a pin of the final link of the push-pull chain and the resilient stop block being fitted in a recess formed in the chain attachment block.

Further objects, features, advantages and properties of the push-pull chain type window actuator according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 is a perspective cut-away view on a push-pull chain type window actuator according to an embodiment of the invention,

FIG. 2 is an elevated view on a push-pull chain type window actuator according to FIG. 1,

FIG. 2a is a detailed cutaway view on a part of the housing and housing elements of the window actuator according to FIG. 1,

FIG. 3 is a cutaway view on the motor and transmission part of the actuator according to FIG. 1,

FIG. 4 is a detailed view on the axial bearing of the push-pull chain type window actuator according to of FIG. 1,

FIG. 5 is a detailed view on the transmission of the push-pull chain type window actuator according to of FIG. 1,

FIG. 6 is a detailed cutaway view on the gearwheels of the transmission of the actuator according to FIG. 1,

FIG. 7 is a detailed elevated cross-sectional view on the transmission of the actuator according to FIG. 1,

FIG. 8 is a detailed cross-sectional side view on the transmission of the actuator according to FIG. 1,

FIG. 9a to 9d are top-, side-detailed cross-sectional and detailed elevated views of the a worm and wormwheel and their tooth profile according to an embodiment of the invention.

### DETAILED DESCRIPTION

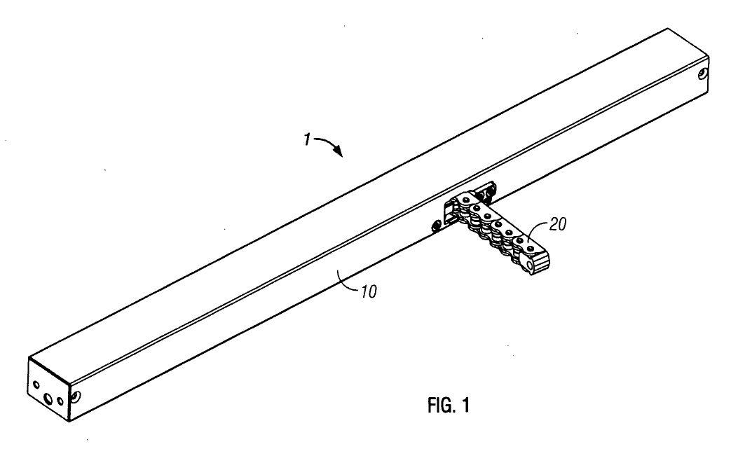

FIG. 1 illustrates a push-pull chain type window actuator 1 according to a preferred embodiment of the invention. The actuator 1 is to be used for automatically opening and closing windows in a building that is at least partially ventilated using so called natural ventilation. The control over the opening and closing of the windows is as such well known and therefore not described in detail here.

The window actuator 1 is operated with a push-pull chain 20 that can bend completely in one direction but only to a very limited extend beyond a position in which the chain is straight in the opposite direction. This characteristic allows the chain to be used to push a load. The chain 20 is provided with rollers and is suitable for engaging a sprocket. When used as a window or door operator for a window or a door with an openable sash structure, the housing will normally be fitted onto or inside a sash or frame profile which is perpendicular to the opening/closing direction, whereas the distal end of the chain, is connected to the opposite frame or sash profile.

The actuator 1 is suitable for being fitted inside a space within a window or door frame. Such frames are typically assembled from elongated profiles or beams, and there is generally ample space in the longitudinal direction, but not in the transverse direction.

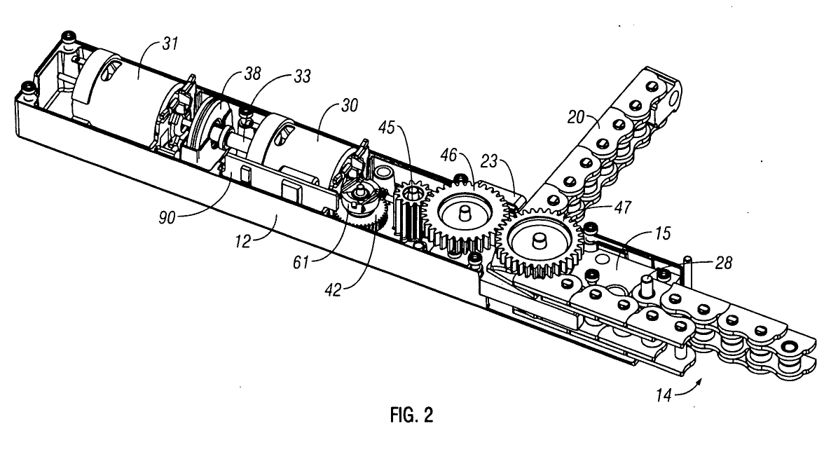

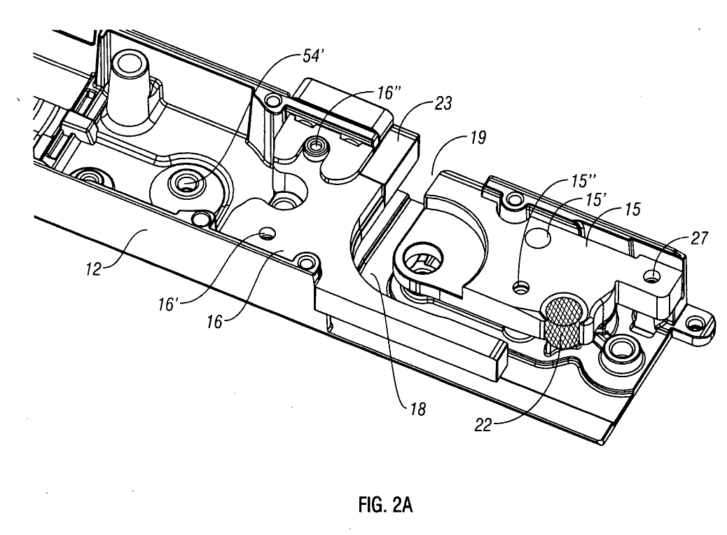

The actuator is composed of an outer housing 10, that can be formed by an extruded metal or plastic profile, and a substantially cuboid inner housing that is longitudinally divided into an upper part or shell 11 and a lower part or shell 12 (FIGS. 2 and 3). The parts of the inner housing have a relatively complicated shape and may therefore be made as a cast shell profile in Zinc, or another metal or alloy or be machined from a solid block in aluminum or another metal or alloy.

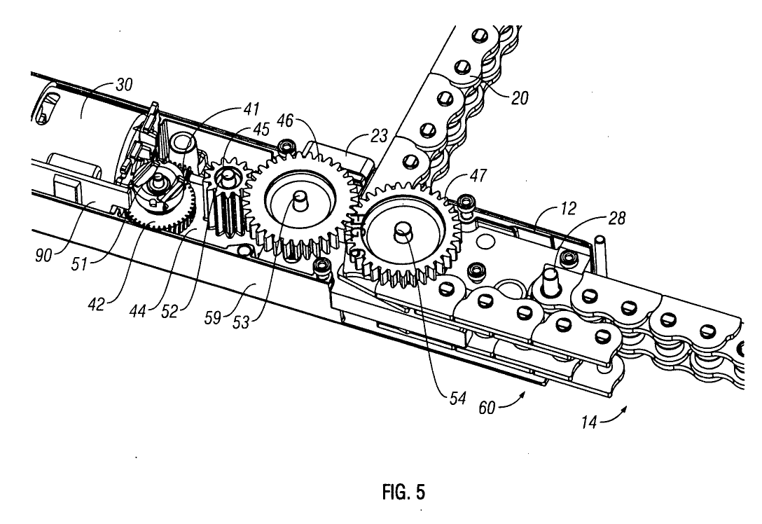

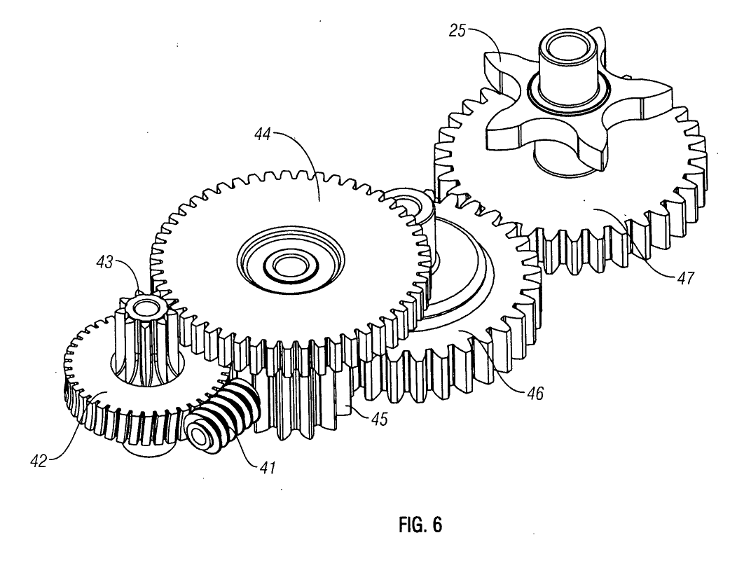

The inner housing is provided with a magazine 14 for storing the chain 20 when it is not fully extended. As shown in FIGS. 2 and 2a, the chain 20 is with its proximate end connected to an attachment block 15 that is secured to the inner housing. The last pin 28 of the chain 20 is received in a bore 27 in the attachment block 15. The attachment block 15 defines together with a guide block 16 a curved chain path 18 that guides the chain from the magazine 14 in an arc along a sprocket 25 (the sprocket is shown in FIG. 3 and in detail in FIG. 6) towards a chain exit 19 and vice versa. The attachment block 15 and the guide block 16 can be made of machined, cast or sintered metal or from molded or machined plastic material. The attachment block 15 and the guide block 16 are each provided with two cylindrical recesses or through-going bores 15′,15″, 16′ (a bolt is received in bore 16″) that are placed over slightly tapered pegs (not visible in any of the Figs) that project upwards from the bottom of the lower inner housing 12. Due to the tapered shape of the pegs the attachment block 15 and the guide block 16 are positioned very precisely and at the same time also secured. Exact positioning is required since the chain fits exactly into the chain path between the two blocks 15,16 with very little play. The two blocks 15,16 are pressed onto the pegs by a dedicated tool (not shown) simultaneously with the shafts 52,53 and 55 (FIG. 3) that are pressed with one of their ends in respective recesses formed in the bottom of the lower housing part 12.

A detachable chain guide 23 is provided at the chain exit 19. The detachable chain guide 23 is fastened to the housing after the actuator 1 has been mounted inside the window or door frame, since the chain guide protrudes from the actuator housing and would otherwise be a hindrance when mounting the actuator inside the window or door frame. The attachment block 15 is provided with a recess in which a rubber chain stop 22 is received. When the chain 20 is close to reaching the fully extended position the last link of the proximate end of the chain 20 pivots about the pin 28 and abuts with the rubber to chain stop 22. The rubber chain stop 22 dampens the halting of the chain 20 when reaching the fully extended position.

The sprocket 25 is driven by two identical electric drive motors 30,31 that are arranged in tandem. The electric drive motors 30,31 are arranged with their drive shafts parallel to longitudinal axis of the inner housing. The electric drive motors are relatively small motors with substantially cylindrical housing so as to obtain small transverse dimensions for the actuator 1. The drive motors are of a type that operates with plastic (e.g. nylon or PTFE) slide bearings 30′,31′ for suspending their steel drive shafts. A printed circuit board 90 includes the electric components for controlling the electric drive motors 30,31.

The rearwardly projecting portion of the drive shaft 39 of the first electric drive motor 30 is connected to forwardly projecting portion the drive shaft 40 of the second electric drive motor 31 by a hollow shaft 33 in which the extremities of the respective drive shafts are received and secured by a push fit. Due to the connection by the hollow shaft 33 the axes of the drive shafts of the two electric drive motors coincide.

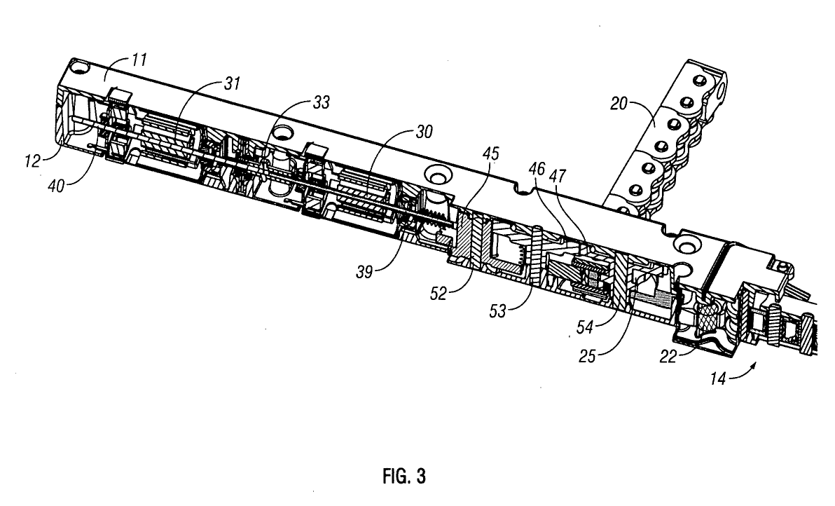

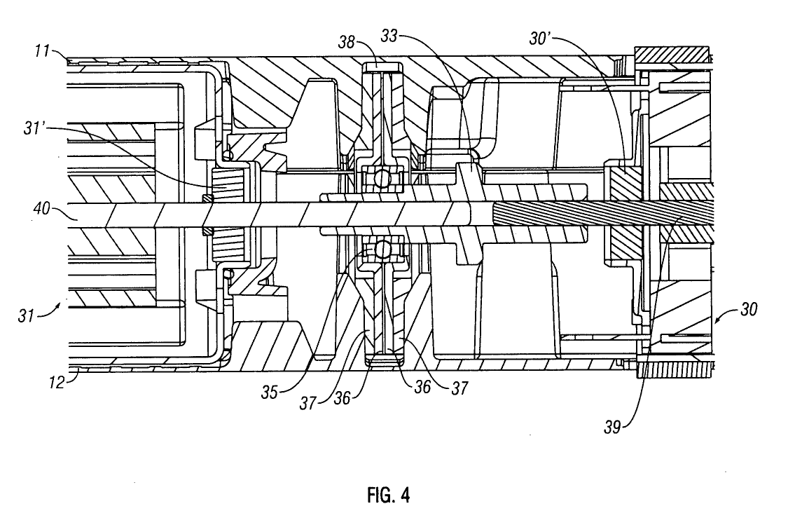

As shown in greater detail in FIGS. 3 and 4, the hollow shaft 33 is supported by a single row deep groove roller bearing 35. The roller bearing 35 carries a major portion of the axial load on the drive shafts 39, 40, so that the plastic slide bearings of the electric drive motors 30,32 are spared. The roller bearing 35 is received in a bearing housing that is formed by two transverse plates 36 with two oppositely countersunk recesses. The transverse plates have a circular circumference and are connected to one another by e.g. spot welding with the roller bearing 35 received in the two opposing recesses. The two traverse plate members 36 are sandwiched between two resilient plate members 37 with a corresponding circular circumference. The resilient plate members 37 can be made from any suitable material such as natural or synthetic rubber or the like. The upper housing 11 and the lower housing 12 each define a recess in which one half of the sandwiched plate arrangement fits tightly. Thus, the roller bearing 35 is resiliently suspended from the inner housing from a point in between the two drive motors. The resilient plate members provide an axial suspension and damping for the drive motors and thereby assist in reducing the noise level of the actuator.

The transmission reduces the relatively high speed at which the electric motors 30,31 deliver their power to the relatively low speed at which the sprocket 25 needs to drive the chain 20. At the input side of the transmission a worm 41 mounted on the forwardly projecting portion of the drive shaft 39 of the first electric drive motor 30. The metal (steel or messing (brass)) worm 41 meshes with a plastic material wormwheel 42 and creates a significant reduction ratio in this first stage of the transmission. Suitable plastic materials for the wormwheel are e.g. nylon, acetal copolymer, polybutylene terephthalate (PBT), linear polyphenylene sulfide (PPS), PTFE-lubricated linear PPS or composites thereof. Preferably a heat resistant plastic resin such as resins containing or largely consisting of polyetheretherketone can be used for the wormwheel 42. The resin can be approximately 30% Glass Filled. With the introduction of glass fibers into the plastic the expansion rate is significantly reduced and the flexural modulus is increased to approximately 1,000,000 psi. This provides high strength, rigidity or stability, especially at temperatures above 150 degrees Celsius. The resin can also be carbon fiber reinforced with graphite and PTFE lubricants. This provides a low coefficient of friction, as well as good machinability.

These types of material are manufactured and sold under the trademarks PEEK and PEEK-HT® by Victrex®. The repeat unit of the VICTREX PEEK polymer comprises oxy-1,4-phenyleneoxy-1,4-phenylene-carbonyl-1,4-phenylene. This linear aromatic polymer is semi-crystalline and is widely regarded as the highest performance thermoplastic material currently available. This material gives the wormwheel excellent wear and heat resistance characteristics (e.g. short term resistance of approximately 300 degrees Celsius and a long term resistance of approximately 260 degrees Celsius) that ensure that the actuator will be able to hold a load also during extreme heat, such as during a fire.

A wheel 61 with two permanent magnets embedded therein is connected to the wormwheel 42 and rotates in unison with the worm 41 about shaft 51 (see also FIG. 5). The position of the permanent magnets is registered by a sensor 94 at the extremity of the printed circuit board 90 close to wheel 61. The signal from the sensor 94 is used by a controller (not shown) on the printed circuit board 90 to control the operation of the actuator.

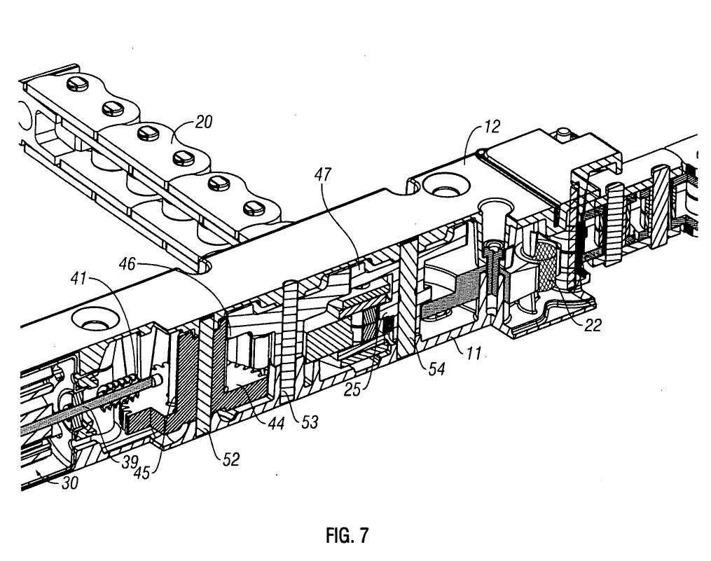

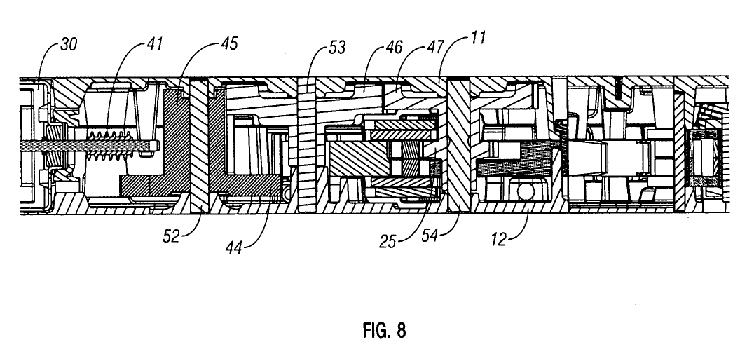

FIGS. 5 to 8 show the other stages of the transmission that are formed by spur gears. A relatively small diameter gearwheel 43 is formed as one unit with the wormwheel 42 and meshes with a relatively large diameter gearwheel 44 that is disposed near the bottom of the lower housing part 12. A shaft 51 is received with its ends in recesses in the opposite walls of the upper lower housing parts 11,12 with gearwheels 42 and 43 and pivoting thereabout. Gearwheel 44 is formed as one unit with a relatively small gearwheel 45 and pivotally mounted on a shaft 52 that is received with its ends in recesses formed in opposite walls of the inner housing parts 11,12. The recess receiving the ends of shaft 52 needs to have a given depth in order to provide a secure fixation of shaft 52. Therefore, wall thickness of the upper housing part 12 is locally increased to be sufficiently thick for forming a stable shaft receiving recess. However, the locally increased wall thickness limits the upward (upward as in the drawings) extent of the gearwheel 45. Gearwheel 45 meshes with a larger gearwheel 46 which in turn meshes with another substantially equally large gearwheel 47 that moves in unison with the sprocket 25. For providing space for a large, strong and stable chain 20, gearwheel 47 is disposed as high as possible up in the housing. In particular the underside of gearwheel 47 is disposed as high as possible. In contrast to the small gearwheel 45, the large gearwheels 46 and 47 can be placed high up in the housing, since they are countersunk, allowing the housing wall thickness around the recess receiving the shafts 53 and 54 to be locally increased by using the space created by the countersink in the gearwheels 46,47. Gearwheel 45 is too small to include a countersink large enough to create space for a locally increased housing wall thickness around the recess in which shaft 52 is received. Therefore, the upper side of gearwheel 52 is lower than the upper side of gearwheels 46 and 47 in order to make place for a locally increased wall thickness.

A given minimum length of engagement between gearwheel 47 and gearwheel 46 and between gearwheel 46 and 45 is required. However, the height span between the upper side of gearwheel 45 and the bottom side of gearwheel 47 does not provide a sufficient length of engagement. Therefore, the width of gearwheel 46 is selected to be higher than that of gearwheel 47 so that a sufficient contact length is created both between the underside of gearwheel 46 and the upper side of gearwheel 45 and the upper side of gearwheel 46 and the underside of gearwheel 47. Thus, the broad gearwheel 46 bridges the step in height (axial displacement) between gearwheel 45 and 47 and provides sufficient contact length with both gearwheel 45 and 47.

The sprocket 25 is placed between the transmission and drive 30,31 motors on one side and the chain 20, the chain path and chain magazine on the other side. Thus, the full width of the actuator housing 10 can be used for the transmission since it does not have to be shared with a chain.

A rotational movement of the sprocket 25 caused by action of the electric drive motors 30,31 causes the chain 20, dependent on the direction of the rotary movement, to move either into or out of the chain path 22.

The inner housing 11,12 stretches only very little beyond the position of the sprocket 25 towards the chain magazine, and the side wall 59 inner housing shells 11,12 stretches no further than shown in FIG. 5. The outer housing 10 assumes the role of encapsulating the internal components of the actuator, in particular the chain on the side of the sprocket where the chain magazine 60 is located. The as shown in FIG. 5 the back of the chain 20 is placed right at the boundary of the lower inner housing art 12 and the back of the chain 20 is guided into the chain magazine 60 by the inner wall of the outer housing.

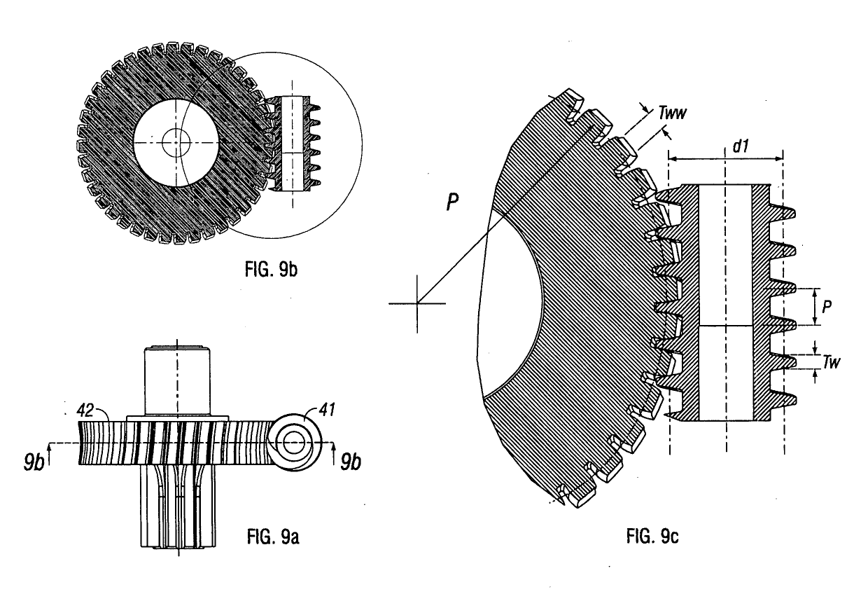

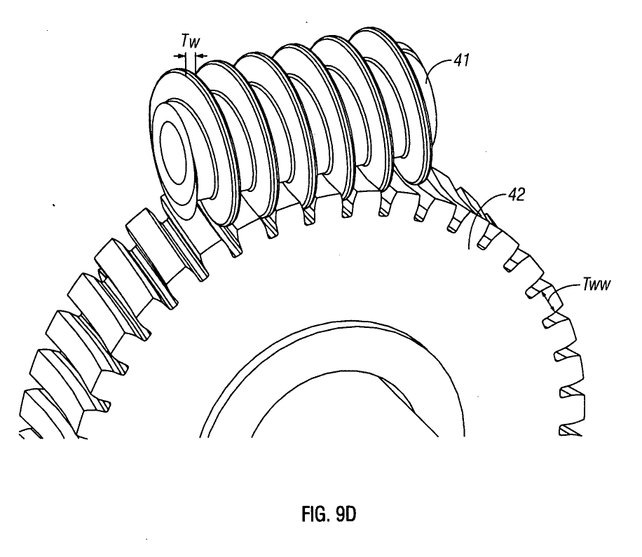

FIG. 9 is a cross-sectional view in detail of a part of a prior art worm 41′ and wormwheel 42′. The worm 41′ is formed of metal, such as messing (brass), or carbon steel for machine structural use, or any other steel. The teeth of the worm 41′ have a substantially trapezoidal shape as viewed in the direction perpendicular to the axis of the worm. The teeth of the worm are formed by a single thread having a pitch P. The pitch circle of worm is indicated by d1.

The worm 41 and the wormwheel 42 according to an embodiment of the invention are illustrated with reference to FIGS. 9a-9d. The worm is made or messing, steel or a suitable metal or alloy. The wormwheel 42 is made of plastic or resin, such as nylon or PEEK® and provided with teeth, with involute flanks. The worm 41 and the wormwheel 42 do not have a standard DIN 867 tooth profile with a standard 20° profile angle. In such a standard tooth profile the tooth thickness T, which is defined as the distance between opposing flanks of a tooth at the pitch radius P, is the same for the teeth of the worm T_{w} and the wormwheel T_{ww}.

In order to increase the durability of the transmission, the tooth thickness T_{w} of the worm 41 is, according to an embodiment of the invention, less than the tooth thickness T_{ww} of the wormwheel 42. The tooth thickness T_{w} of the teeth of the worm 41 is preferably approximately half of the tooth thickness T_{ww} of the wormwheel 42. Thus, the tooth thickness T_{ww} of the teeth of the wormwheel 42 is increased significantly (relative to a wormwheel with conventional teeth) and the tooth thickness T_{w} of the worm 41 is reduced significantly (relative to a worm with conventional teeth). Reducing the thickness T_{w} of the teeth of the worm 41 is facilitated by reducing the profile angle, i.e. the angle between a tangent to a tooth profile and the radius from the gear axis to the tangent point. In the shown embodiment the profile angle is reduced from the standard 20° to 10°. The reduced tooth thickness T_{w} of the teeth of the worm 41 does not have any substantial negative effects on the durability of the teeth of the worm 41, since the metal teeth of the worm 41 do in operation not wear off against the plastic teeth of the wormwheel 42. However, the plastic teeth of the wormwheel 42 do wear off on the metal teeth of the worm 41. With the increased tooth thickness T_{w} it will under otherwise identical circumstances take significantly longer for the teeth of the wormwheel 42 to wear off to a level at which the transmission fails.

The profile of the cutting tool has normally an angle of 20°. In order to obtain a lower tooth thickness for the teeth of the worm 41, the profile of the cutting tool has been reduced from 20 to 10 degrees which means that a special cutting tool (not shown) needs to be used.

Thus, while the preferred embodiments of the devices and methods have been described in reference to the environment in which they were developed, they are merely illustrative of the principles of the invention. Other embodiments and configurations may be devised without departing from the scope of the appended claims.

1. A push-pull chain type window actuator for mounting inside or on a window frame comprising:
a sprocket,
an elongated and slim actuator housing provided with a chain path in communication with a chain exit opening,
a push-pull chain being at least partially received in the chain path and being engaged by the sprocket, and
an electric drive motor with a drive shaft coupled to the sprocket via a transmission,
characterized by comprising at least one further electric drive motor with a drive shaft coupled to rotate in unison with the drive shaft of said electric motor.

2. A push-pull chain actuator according to claim 1, wherein the axis of the drive shaft of said electric drive motor is arranged substantially in parallel with the longitudinal axis of said housing.

3. A push-pull chain actuator according to claim 1, wherein the axis of the drive shaft of said electric drive motor and the axis of the drive shaft of said at least one further electric drive motor substantially coincide.

4. A push-pull chain actuator according to claim 3, wherein the opposite ends of the drive shaft of said electric drive motor protrude from the opposite sides of the housing of said electric drive motor, whereby the drive shaft of said at least one further electric drive motor is coupled to one of said opposite ends whilst said transmission is coupled to the other one of said opposite ends.

5. A push-pull chain actuator according to claim 3, wherein said drive shaft of said electric drive motor and the axis of the drive shaft of said at least one further electric drive are substantially rigidly connected to one another.

6. A push-pull chain actuator according to claim 5, wherein said drive shaft of said electric drive motor and the axis of the drive shaft of said at least one further electric drive are connected to one another by a connecting shaft with hollow ends in which the respective drive shafts are received.

7. A push-pull chain actuator according to any of claim 1, wherein said transmission comprises wormwheel and a worm, the worm being driven by one of said drive shafts.

8. A push-pull chain actuator according to claim 7, herein said worm is mounted on an end of the drive shaft of said electric drive motor.

9. A push-pull chain actuator according to claim 8, wherein the other end of the drive shaft of said electric drive motor is coupled to the end of the drive shaft of said further electric drive motor by a direct mechanical connection.

10. A push-pull chain actuator according to any of claims 1, wherein said electric drive motor and said further electric drive motor have substantially cylindrical housings with equal diameters.

11. A push-pull chain actuator according to claim 10, wherein the elongated housing has a substantially cuboid shape, and whereby at least one of the two traverse dimensions of the housing is substantially equal to the diameter of the housing of said electric drive motor and said further electric motor.

12. A push-pull chain actuator according to any of claims 1, further comprising a supplementary axial bearing supporting one or both of said drive shafts, preferably an axial bearing that engages said connecting shaft.

13. A push-pull chain actuator according to claim 12, wherein the supplementary axial bearing is resiliently suspended from the housing.

14. A push-pull chain type window actuator for mounting inside or on a window frame comprising:
an elongated and slim actuator housing provided with a chain path in communication with a chain exit opening,
a push-pull chain being at least partially received in the chain path and operably coupled to a drive mechanism including a worm and wormwheel,
an electric drive motor, said wormwheel being mounted on the drive shaft of said electric drive motor,
characterized by a supplementary axial bearing supporting said drive shaft.

15. A push-pull chain actuator according to claim 14, wherein said supplementary axial bearing is at least in an axial direction resiliently suspended from said housing.

16. A push-pull chain actuator according to claim 14, wherein said supplementary axial bearing is rigidly connected to a traverse plate member.

17. A push-pull chain actuator according to claim 16, wherein said plate member is sandwiched between two resilient plate members.

18. A push-pull chain actuator according to claim 17, wherein said plate member and said resilient plate member fit tightly in a recess in said elongated slim housing.

19. A push-pull chain actuator according to claim 17, wherein said plate member and said resilient plate members have a substantially circular contour.

20. A push-pull chain actuator according to any of claims 14, wherein said axial bearing is a deep groove roller bearing, preferably a single row deep groove ball bearing.

21. A push-pull chain actuator according to any of claims 14, wherein said electric drive motors are equipped with slide bearings, preferably slide bearings with a plastic or PTFE bearing surface in collaboration with a steel drive shaft.

22. A push-pull chain type window actuator for mounting inside or on a window frame comprising:
an elongated and slim actuator housing provided with a chain path in communication with a chain exit opening,
a push-pull chain being at least partially received in the chain path and being operably coupled to a drive mechanism including a metal worm meshing with a non-metallic wormwheel,
an electric drive motor, said worm being mounted on the drive shaft of said electric drive motor,
characterized in that,
the tooth thickness of the teeth of the worm is substantially smaller than the tooth thickness of the teeth of the wormwheel.

23. A push-pull chain actuator according to claim 22, wherein the profile angle—the angle between a tangent to a tooth profile and the radius from the gear axis to the tangent point—of the worm and the wormwheel is substantially less than 20°, preferably between 8 and 16°.

24. A push-pull chain actuator according to claim 22, wherein the worm is formed of carbon steel and the wormwheel is made of a plastic resin.

25. A push-pull chain actuator according to claim 22, wherein the tooth thickness of the teeth of the worm are equal to or less than half of the tooth thickness of the wormwheel.

26. A push-pull chain type window actuator comprising:
a sprocket
an elongated and slim actuator housing provided with a chain path in communication with a chain exit opening,
a push-pull chain being at least partially received in the chain path and being operably coupled to a drive mechanism including a metal worm meshing with a non-metallic wormwheel,
an electric drive motor, said worm being mounted on the drive shaft of said electric drive motor,
a spur gear with at least two stages, with a first gear wheel meshing with a second gearwheel to form the first stage and the second gear wheel meshing with a third gearwheel to form the second stage,
characterized in that,
the second gearwheel has a given width at its meshing edge,
said first gearwheel meshes with said second gearwheel in a first contact length that is less than the width of said meshing edge and the first contact length extends along said width starting from a first side of said second gearwheel towards the second opposite side of said second gearwheel,
said third gearwheel meshes with said second gearwheel in a second contact length that is less than the width of said meshing edge, and the second contact length extends along said width starting from said second side of the second gearwheel towards the first side of the second gearwheel.

27. A push-pull chain type window actuator according to claim 26, wherein the third gearwheel is axially displaced relative to the first gearwheel.

28. A push-pull chain type window actuator according to claim 27, wherein said first-, second-, and third gearwheels are each mounted on a shaft, the ends of each of said shafts being received in recesses in oppositely disposed walls of a housing.

29. A push-pull chain type window actuator according to claim 28, wherein said first gearwheel is a relatively small diameter gearwheel in which and the second- and third gearwheels are relatively large diameter gearwheels provided with a countersink in a side of the gearwheel adjacent a housing wall.

30. A push-pull chain type window actuator comprising:
a sprocket,
an elongated and slim actuator housing provided with a chain path in communication with a chain exit opening,
a push-pull chain being at least partially received in the chain path and being engaged by the sprocket,
an electric drive motor with a drive shaft coupled to the sprocket via a transmission, and
said push pull chain having a distal end of connection to a window sash to be actuated and a proximate end pivotally attached to the actuator housing,
the final link at the proximate end of the push pull chain swinging from a first orientation to another orientation during the final part of the outward movement of the push-pull and abuts with a resilient rubber stop block disposed in the actuator housing to thereby dampen the halt of the push pull chain at the end of its outward stroke.

31. A push-pull chain actuator according to claim 30, wherein the actuator housing includes a chain attachment block provided with a bore for receiving a pin of the final link of the push-pull chain and the resilient stop block being fitted in a recess formed in said chain attachment block.
